(19) United States
(12) Patent Application Publication
(10) Pub. No.: US 2015/0153949 A1
(43) Pub. Date: Jun. 4, 2015

(54) TASK SELECTIONS ASSOCIATED WITH TEXT INPUTS

(71) Applicant: Google Inc., Mountain View, CA (US)

(72) Inventors: Bryan Russell YEUNG, Waterloo (CA); John Nicholas JITKOFF, Palo Alto, CA (US); Alexander Friedrich KUSCHER, San Francisco, CA (US)

(73) Assignee: Google Inc., Mountain View, CA (US)

(21) Appl. No.: 14/095,944

(22) Filed: Dec. 3, 2013

(51) Int. Cl. G06F 3/0488

(52) U.S. Cl. CPC G06F 3/04886

(57) ABSTRACT

A system and machine-implemented method for performing tasks associated with text inputs, the method including providing a text input mechanism on an electronic device, receiving, at the electronic device, an input by a user using the text input mechanism, determining if the input corresponds to a text selection or task selection, wherein a text selection corresponds to the user entering an actual text input through the text input mechanism and a task selection corresponds to the user requesting to perform a task related to text entered at the device, registering a key corresponding to the input if the input corresponds to a text selection and performing a task corresponding to the input if the input corresponds to a task selection.

### BACKGROUND

As electronic devices equipped with touchscreens have become increasingly popular, virtual keyboards have also become popular. Typing on virtual keyboards often corresponds to various tasks. However, performing these tasks may require that a user switch from the virtual keyboard interface to a different non-keyboard user interface to make the selection. The switching of interfaces can often impede the user experience in inputting additional words or phrases with the virtual keyboard.

### SUMMARY

The disclosed subject matter relates to a machine-implemented method for performing tasks associated with text inputs, the method comprising providing a text input mechanism on an electronic device. The method further comprising receiving, at the electronic device, an input by a user using the text input mechanism. The method further comprising determining if the input corresponds to a text selection or task selection, wherein a text selection corresponds to the user entering an actual text input through the text input mechanism and a task selection corresponds to the user requesting to perform a task related to text entered at the device. The method further comprising registering a key corresponding to the input if the input corresponds to a text selection and performing a task corresponding to the input if the input corresponds to a task selection.

The disclosed subject matter also relates to a system for performing tasks associated with text inputs, the system comprising one or more processors and a machine-readable medium comprising instructions stored therein, which when executed by the processors, cause the processors to perform operations. The operations comprising receiving, at an electronic device, an input by a user using a text input mechanism. The operations further comprising determining according to one or more criteria if the input corresponds to a text selection or task selection, wherein a text selection corresponds to the user entering an actual text input through the text input mechanism and a task selection corresponds to the user requesting to perform a task, wherein the one or more criteria include characteristics of the input and context of the input. The operations further comprising identifying a key corresponding to the input if the input corresponds to a text selection and identifying a task corresponding to the input if the input corresponds to a task selection.

The disclosed subject matter also relates to a machine-readable medium comprising instructions stored therein, which when executed by a machine, cause the machine to perform operations comprising providing a text input mechanism on an electronic device, the text input mechanism comprising a virtual mechanism for inputting text. The operations further comprising receiving, at the electronic device, an input by a user at the text input mechanism. The operations further comprising determining based on information regarding the input if the input corresponds to a text selection or task selection, wherein a text selection corresponds to the user entering an actual text input through the text input mechanism and a task selection corresponds to the user requesting to perform a task related to text. The operations further comprising registering a key corresponding to the input if the input corresponds to a text selection and performing a task corresponding to the input if the input corresponds to a task selection.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example of a client device for implementing various aspects of the subject disclosure.

FIG. 2 illustrates an example of system for allowing text entry inputs and task inputs on a text input mechanism

FIG. 3 illustrates an example flow diagram of a process for facilitating select tasks associated with text inputs.

FIG. 4A illustrates an example in which a user input corresponding to a text selection is entered using a virtual keyboard.

FIGS. 4B, illustrates an example in which a user input corresponding to a task selection is entered using a virtual keyboard.

FIGS. 5A-5D, illustrate other examples in which user inputs corresponding to text and task selections are entered using a virtual keyboard.

FIG. 6 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Often a user keyboard entry corresponds to and/or is associated with one or more selection tasks (e.g., menu navigation or selection, text field navigation or selection, word prediction navigation or selection, etc.). Traditionally, the mechanism for text entry (e.g., a keyboard) and the mechanism for selection (e.g., touch, cursor, mouse, or other selection mechanism) have been distinct. This means that when the user wishes to select a selection task related to a text entry, the user has to switch between two input mechanisms (e.g., from a keyboard to a selector). In certain instances (e.g., devices where a limited display is available or a single input is selectable at a time such as devices with touch screens, UI keyboards, virtual keyboards, etc.) the user has to switch between input mechanisms, use another UI and/or close one input mechanism (e.g., the text input mechanism), when performing a task relating to a text input.

According to various aspects of the subject technology, systems and methods are provided for allowing a user to select tasks associated with text inputs in a quick and efficient manner. In some aspects, scrubbing and selection gestures by the user can be entered and detected on the text input mechanism (e.g., a virtual keyboard, layout of key or their text input user interface (‘UI”). The detected gestures may be translated to selections, which would otherwise be entered using a separate selection mechanism. The determination as to whether an input received at the text input mechanism is a text input or task input is based on various criteria that differentiate between such inputs. Once it is determined that the user wishes to perform a task, rather than entering text, through the text input mechanism, the system recognizes the gesture (e.g., based on the specific set of related tasks available) and translates the input at the text input mechanism to a task input. The task input then causes a task to be performed that would otherwise be performed by the user directly through a separate selection mechanism.

The tasks may be in response to items being displayed in association with the text and/or corresponding to the text being entered using the text input mechanism. For example, in some implementations, the related task may include a navigation through and/or selection of a text suggestion being displayed to the user in response to the user entering text (e.g., using the text input mechanism). In one example, a text suggestion may include a correction (e.g., autocorrect) or completion (e.g., autocomplete) of the text being entered. For example, the text input may include a first portion of a word or phrase, and a text suggestion may include a second portion of the word or phrase. Alternatively, the text input may include a word or phrase having an error, and the suggestion may include the word or phrase without the error. The error may, for example, include a grammatical, spelling, punctuation, and linguistic error.

In some implementations, the related task may be related to a menu being displayed, for example, in response to text being entered using the text input mechanism. For example, contextual menus or other menus (e.g., providing autocomplete suggestions, text suggestions, options for filling out forms or similar options) may be displayed in display area 101 of device 100. In some implementations, the related task may involve moving from one text entry field to another text entry field (e.g., field or page).

In one example, the related tasks may include a selection of one of a plurality of options (e.g., text suggestions, options in the menu, or text fields). In one example the plurality of options are arranged along one or more axis (e.g., X, Y), and the input (e.g., swipe gesture) is substantially parallel to at least one of the axis.

By allowing the user to perform gestures relating to tasks on the text input mechanism (e.g., virtual keyboard), the user is able to perform related tasks without switching between different user interfaces. In this manner the text input mechanism (e.g., virtual keyboard) is the singular point of entry for the user, and the user can easily switch between text input and task inputs and/or quickly continue inputting additional words or phrases after selecting to perform a specific task (e.g., navigating text suggestions, selecting a text suggestion, navigating a menu, selecting a menu item, navigating a page or fields of a page, or selecting an item or field in a page).

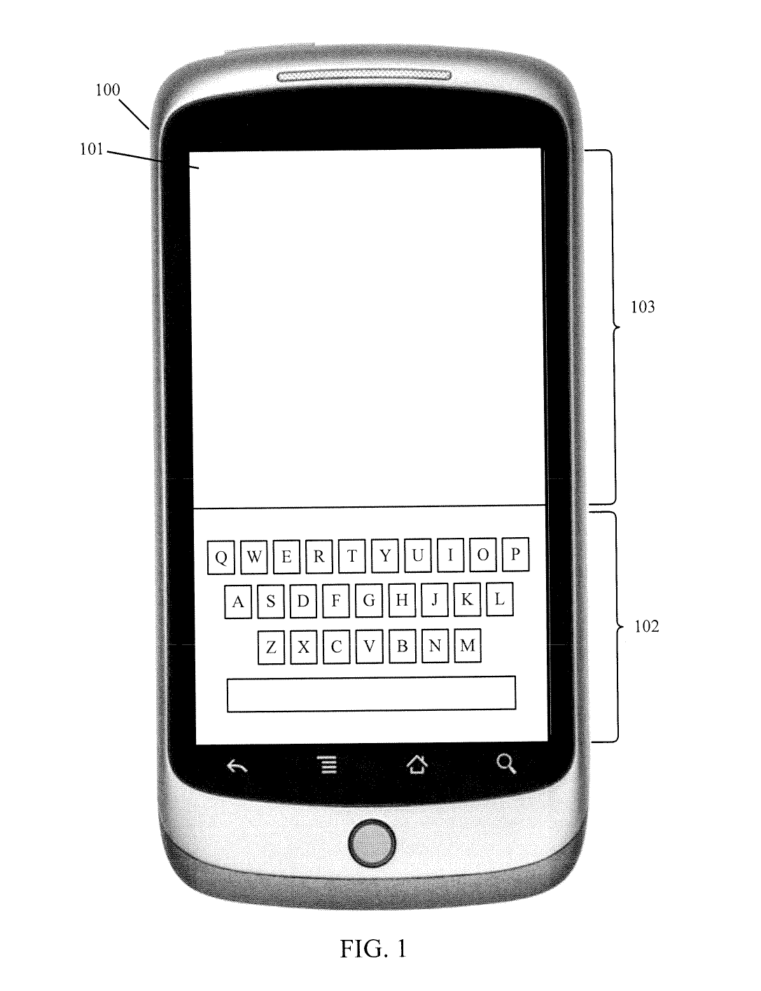

FIG. 1 illustrates an example of a client device for implementing various aspects of the subject disclosure. The device 100 is illustrated as a mobile device equipped with touchscreen 101. In some implementations, the touch screen 101 includes a virtual keyboard 102 and a display area 103. Virtual keyboard 102 provides a text input mechanism for the device 100 and may be implemented using touchscreen 101. Display area 103 provides for display of content (e.g., menus) at the device 100. Device 100 may further include a selection mechanism (e.g., through touch, or pen) for selection of items displayed within display area 103 of touch screen 101.

Although device 100 is illustrated as a smartphone, it is understood the subject technology is applicable to other devices that may implement text input and/or selection mechanism as described herein (e.g., devices having touch capability), such as personal computers, laptop computers, tablet computers (e.g., including e-book readers), video game devices, and the like. Although touchscreen 101 is described as including both input and display capability, in one example, the device 100 may include and/or be communicationally coupled to a separate display for displaying items. In one example, the touchscreen 101 may be implemented using any device providing an input mechanism providing for text input (e.g., through a virtual keyboard) and/or selection (e.g., through touch or pen).

As shown in FIG. 1, the keys of virtual keyboard 102 include alphabet characters and are laid out according to the QWERTY format. However, virtual keyboard 102 is not limited to keys that pertain only to alphabet characters, but can include keys that pertain to other non-alphabet characters, such as numbers, symbols, punctuation, and/or other special characters. According to certain aspects, a user may perform a gesture (e.g., tapping and holding onto a particular key) to display keys that pertain to other non-alphabet characters. In this regard, the keys that are initially provided by virtual keyboard 102 may be referred to as primary keys, while the keys that are provided after the user performs a gesture and subsequently displayed may be referred to as secondary keys.

Although virtual keyboard 102 is described herein as being a user interface that is displayed to the user, the subject technology is equally applicable to keyboards that are not displayed to users (e.g., keyboards that do not have any keys visible to the user). For example, a touchpad, track pad, or touch screen may be used as a platform for a virtual keyboard. The touchpad, track pad, or touch screen may be blank and may not necessarily provide any indication of where keys would be. Nevertheless, a user familiar with the QWERTY format may still be able to type as if the keyboard were still there. In this regard, the input from the user may still be detected in accordance with various aspects of the subject technology. In some aspects, a menu or any other suitable mechanism may be used to show the user which keys the user may select. For example, a menu may be displayed to show the user which keys the user may select.

A user may perform a gesture (e.g., a tap or a swipe) at the virtual keyboard in an attempt to select a particular key. In addition the user may perform a gesture at the virtual keyboard 102 to perform a task relating to the text entry. For example, tasks relating the text entry may be displayed within display area 103 of touch screen 101 (e.g., a menu, text recommendations, text fields, etc.). In one example, when the user performs a gesture, mobile device may determine if the gesture is to select a particular key or to perform a task. The determination may be based on a number of criteria that distinguish a text input and a task input on the keyboard 102. In one example, the criteria may include velocity, direction, context, and/or other similar criteria. In one example, the context may include whether a task is available for selection. In one example, the context includes a combination of criteria including the text entered, the tasks available and/or displayed, velocity of selection, direction of selection, duration of selection, historical information regarding user selection and/or preferences, and/or other criteria that may distinguish a text entry and task input at the virtual keyboard 102. The device 100 may determine the selection type and perform a task in response to the determination.

In one example, where it is determined that the user performed a gesture (e.g., a tap or a swipe) in an attempt to select a particular key, device 100 may detect the gesture and determine which key to register as the intended text input from the user. For example, if the user taps a point on touchscreen 101 corresponding to the “S” key of virtual keyboard 102, device 100 may detect the tap at that point, and determine that the tap corresponds to the “S” key. Device 100 may therefore register the “S” key as the input from the user. Device 100 may then display the letter “S” in the display area 103, for example in a text field, thereby providing an indication to the user that the “S” key was registered as the actual input.

In some examples, when it is determined that the user performed a gesture (e.g., a tap or swipe) in an attempt to perform a task, device 100 may detect the gesture and determine the task being performed. In one example, the device 100 may determine the task based on the tasks available and/or being displayed to the use. For example, where text recommendations are provided to a user, and, for example, in relation with text, the user performs a swipe, the device 102 may determine that the desired task is to move to and/or select the text recommendation in accordance with the swipe (e.g., shape and/or direction of the swipe). In one example, where a menu is being displayed, and the user performs a swipe, the device 102 may determine that the task being performed is to navigate and/or select an option of the options in the menu. In another example, where the page includes text fields, a swipe or touch by the user may be detected as a desire to move to a different text field on the page. Once the task to be performed is detected, the related task is performed (e.g., as if the task was performed using the appropriate selection mechanism such as a touch or pen).

In one example, the input may be continuous after the previous input (e.g., by continuing from the termination location of the previous input such as the location of key of a text input or the ending location of a task input) and/or may be initiated as a separate gesture (e.g., by lifting off the touchscreen after entering the input and again tapping the touchscreen to initiate the input).

In some examples, when it is determined that the performed gesture corresponds to a task input (e.g., rather than a text entry input), the device 100 may determine one or more key entries detected during the gesture (e.g., the point of initiation of the entered gesture, one or more middle points or the point of termination of the gestures) and discard the one or more entries as key selection(s). For example, where the input is initiated independently (e.g., not continuous from the last input), the point of initiation may correspond to a key on the virtual keyboard 102 and may be discarded as a key entry.

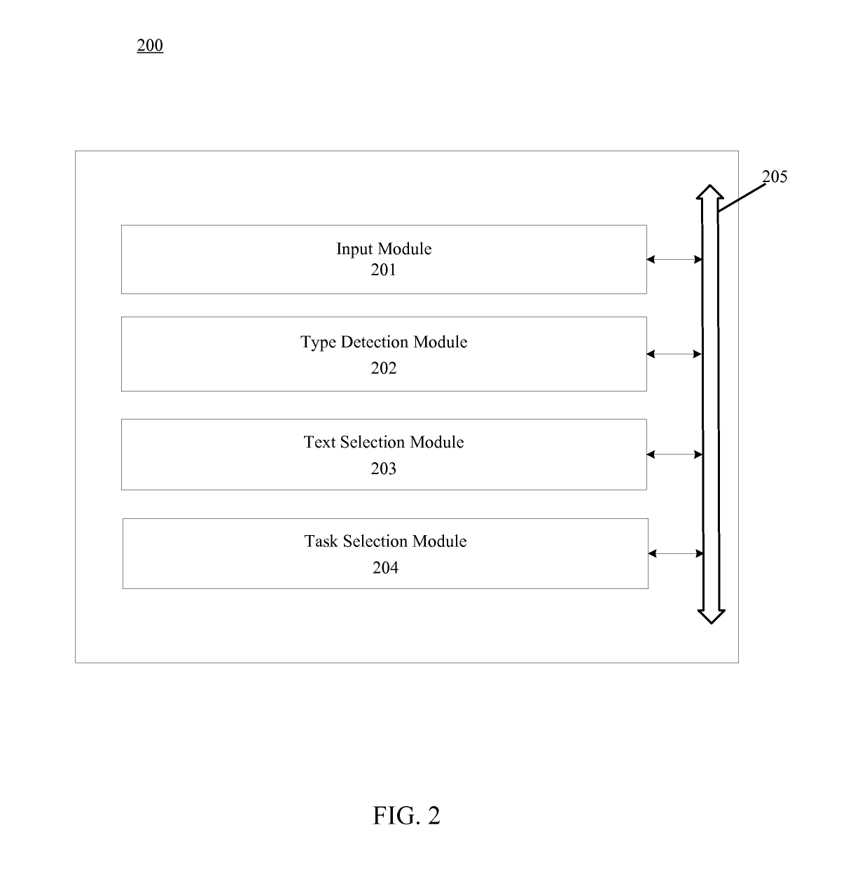

FIG. 2 illustrates an example of system 200 for allowing text entry inputs and task inputs on a text input mechanism, in accordance with various aspects of the subject technology. System 200, for example, may be part of device 100. System 200 comprises input module 201, type detection module 202, text selection module 203 and task selection module 204. These modules may be in communication with one another. In one example, the modules 201, 202, 203 and 204 are coupled through a communication bus 205. In one example, the input module 201 is configured to receive an input at a text input mechanism (e.g., virtual keyboard). In one example, the input mechanism 201 provides the input to type detection module 202, which determines if the input corresponds to a text input or a task input. If the type detection module 202 determines that the input corresponds to a text selection, the text selection module 203 determines the key being selected and registers the text input. Otherwise, the task selection module 204 receives the input and determines a task corresponding to the input and performs the task. In one example, the task selection module sends a request to perform the determined task at the device.

In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

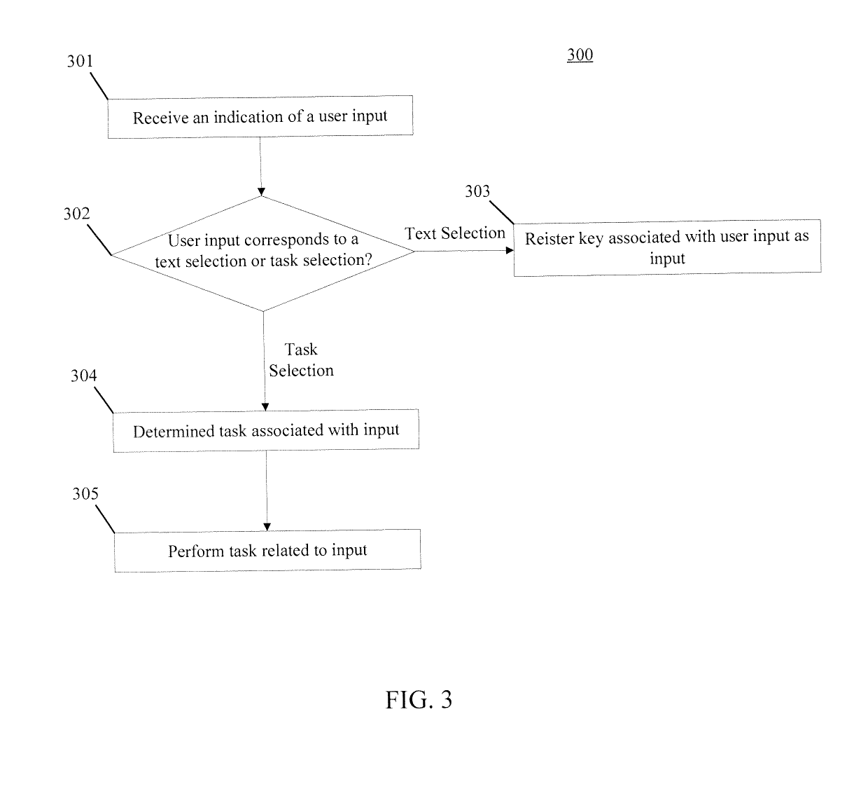

FIG. 3 illustrates an example flow diagram of a process 300 for facilitating select tasks associated with text inputs. System 200, for example, may be used to implement method 300. However, method 300 may also be implemented by systems having other configurations. In step 301, an indication of a user input is received. The input, for example, may be a tap or swipe or other gesture performed on a text input mechanism (e.g., virtual keyboard 102).

In step 302, the user input is analyzed to determine if the user input corresponds to a text selection or a task selection. The determination, as described above, may be based on different criteria including the context of the user input as well as the characteristics of the user input. For example, in one example, input characteristics such as duration, velocity, position (e.g., starting and/or ending position), and/or direction may be used to determine if the user input corresponds to a text or task selection. In some implementations, context information such as items provided for display at the device (or a coupled device), previous text inputs, previous user activity and behavior, user preferences and/or user and/or system settings may be taken into account when making the determination in step 302.

If, in step 302, it is determined that the user input corresponds to a text selection, the process continues to step 303. In step 303, the key associated with the user input is registered as the input. The user input may be analyzed to determine which key to register as the intended input from the user. In one example, an indication of the key being registered as the input is provided for display to the user (e.g., displayed in the display area 103).

Otherwise, if it is determined that the user input corresponds to a task input in step 302, in step 304, the task associated with the input is determined. In one example, the device 100 may determine the task based on the items being displayed to the user. In some examples, criteria described above, including the characteristics of the user input and/or context of the user input may be used to determine the task associated with the input. In step 305, the task determined in step 304 is performed. The task may include menu navigation and/or selection, text field and/or page navigation and/or selection, text recommendation navigation and/or selection or other similar activity.

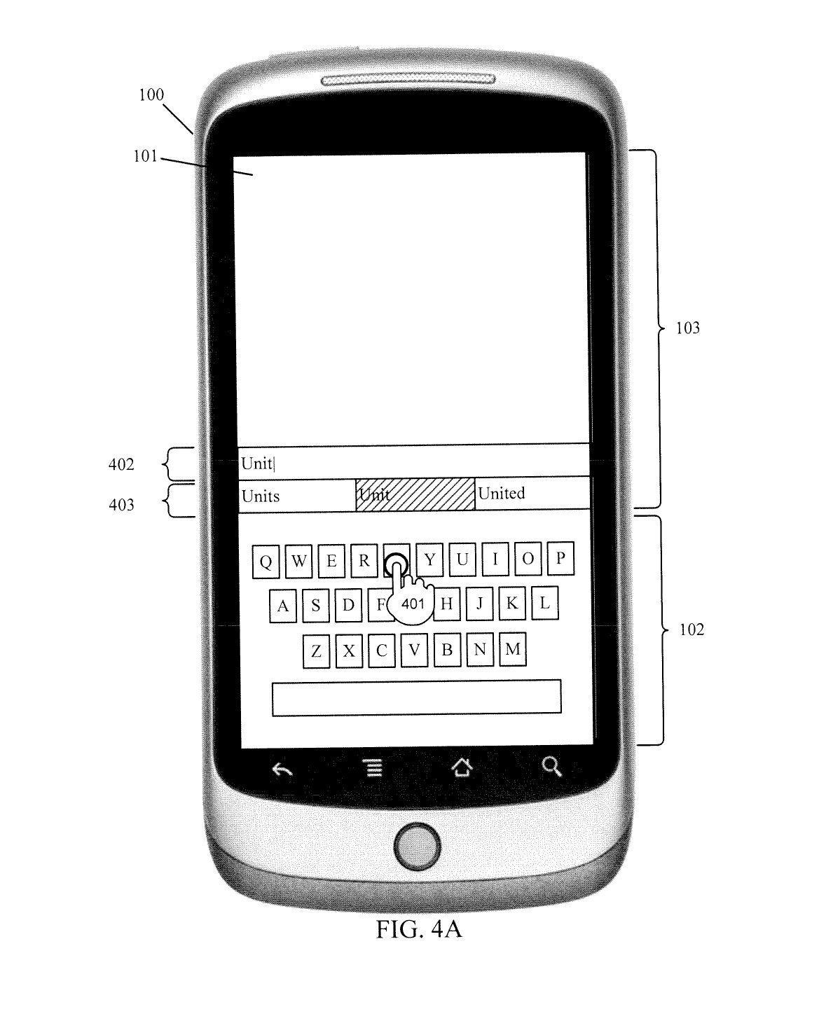

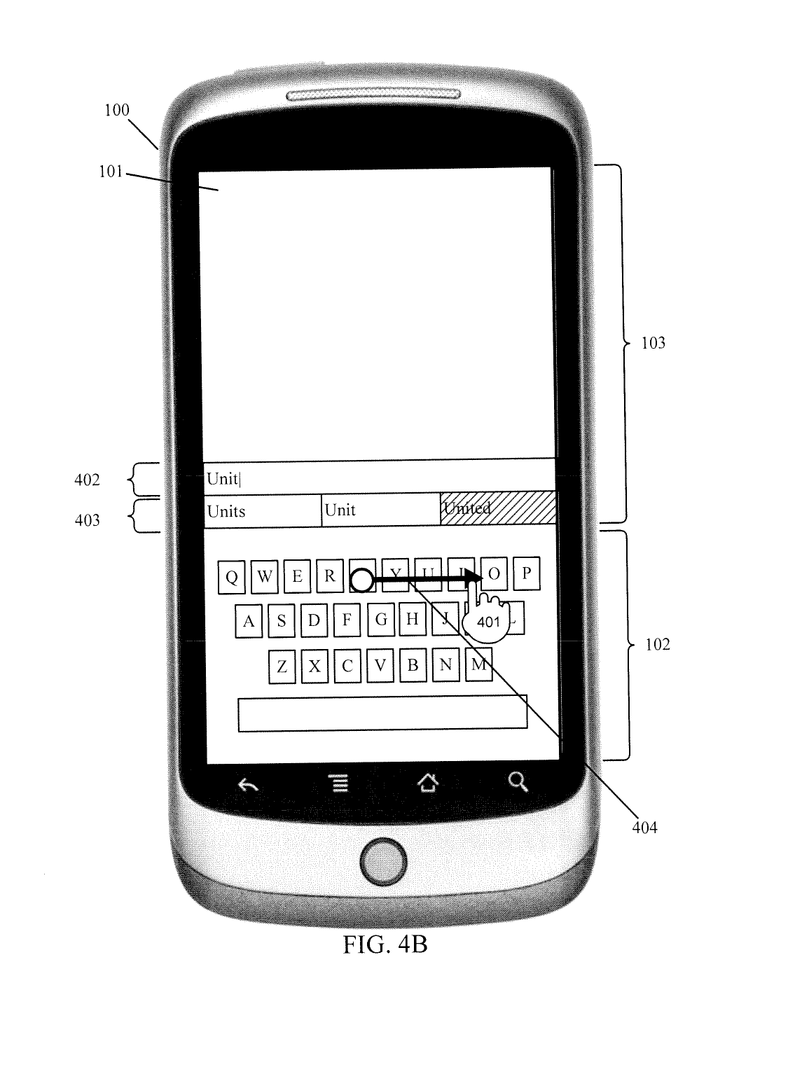

FIG. 4A illustrates an example in which a user input corresponding to a text selection is entered using a virtual keyboard, in accordance with various aspects of the subject technology. As shown in FIG. 4, the index finger of hand 401 of the user taps touchscreen 101 on the “T” key. A determination is made (e.g., at the selection type detection module 202) as to the type of input according to the methods described and it is determined that the tap refers to an actual text input. Thus, the “T” key is registered as the user input (e.g., at the text selection module 204). The letter “T” is provided for display in the text field 402, thereby providing an indication to the user that the “T” key was registered as the input.

FIGS. 4B, illustrates an example in which a user input corresponding to a task selection is entered using a virtual keyboard, in accordance with various aspects of the subject technology. As shown in FIGS. 4A and 4B, a set of text recommendations are provided to a user in text recommendation area 403 of the display area 103. The text recommendations may be generated according to different techniques and provided for display at the device 100. The finger of hand 401 may make a gesture 404 by moving in the right direction across the virtual keyboard 102. In one example, the gesture may be continuous after the text selection shown in FIG. 4A or may be initiated as a separate gesture (e.g., by lifting the finger of hand 401 off the touchscreen after entering the last text selection and again tapping the touchscreen to initiate the input). According to characteristics of gesture 404 and the context of the gesture 404 it is determined that the user wishes to move across the text recommendations. Accordingly, as shown in FIG. 4B, the text recommendation moves from the center (e.g., default) recommendation “Unit” to the right recommendation “United.” As shown in FIG. 4B, an indication of the task being performed is shown to the user.

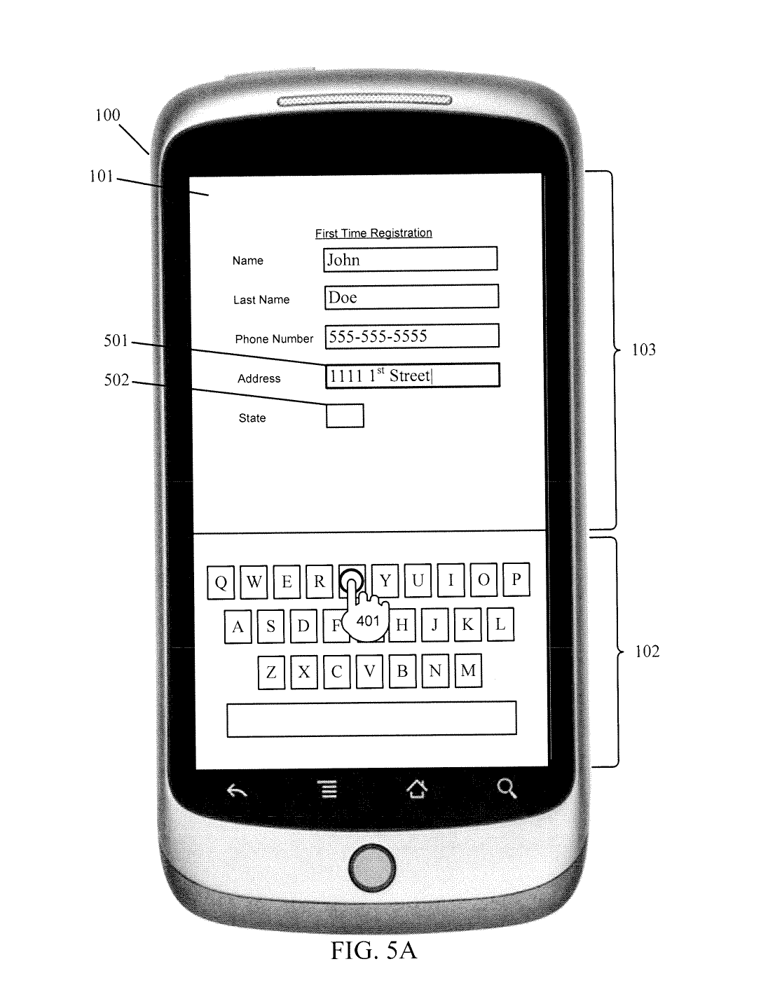

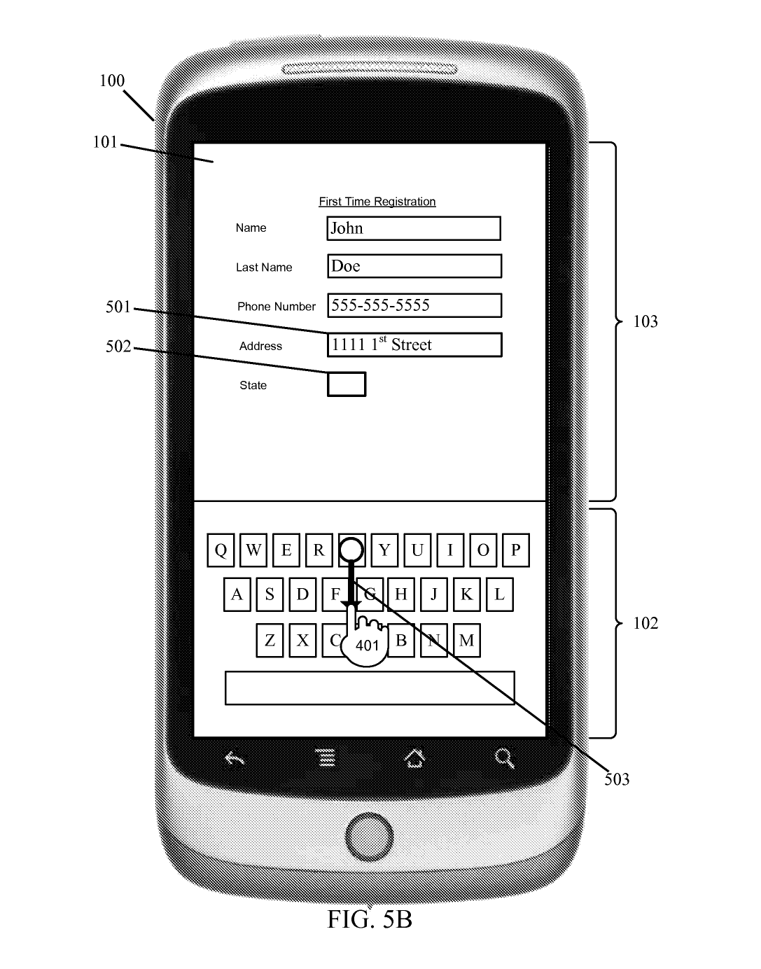

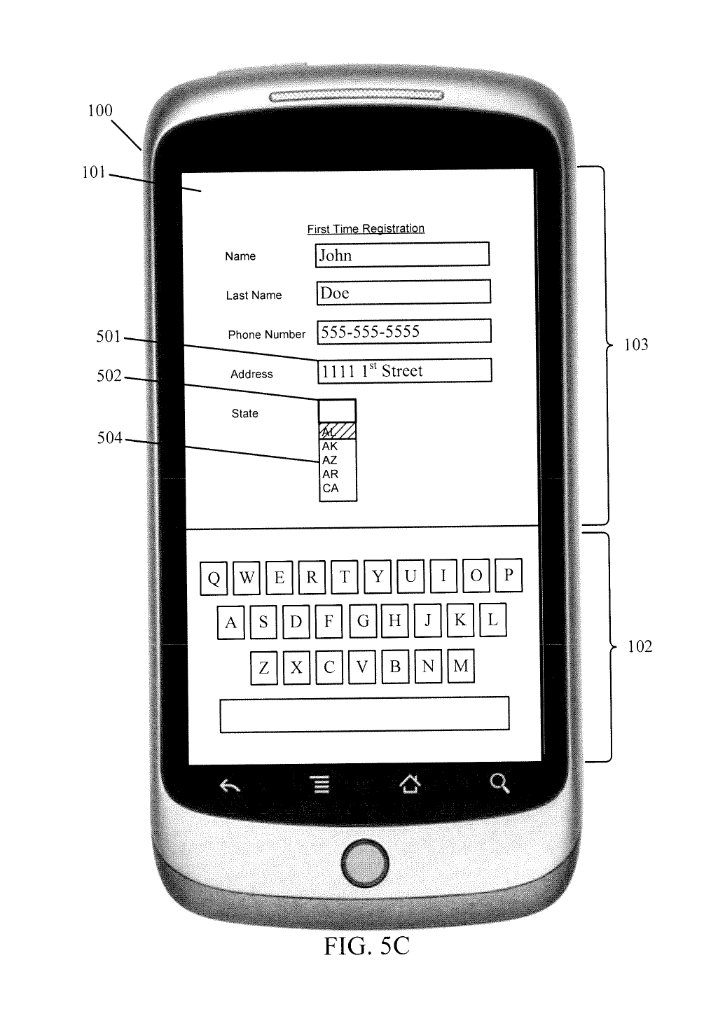

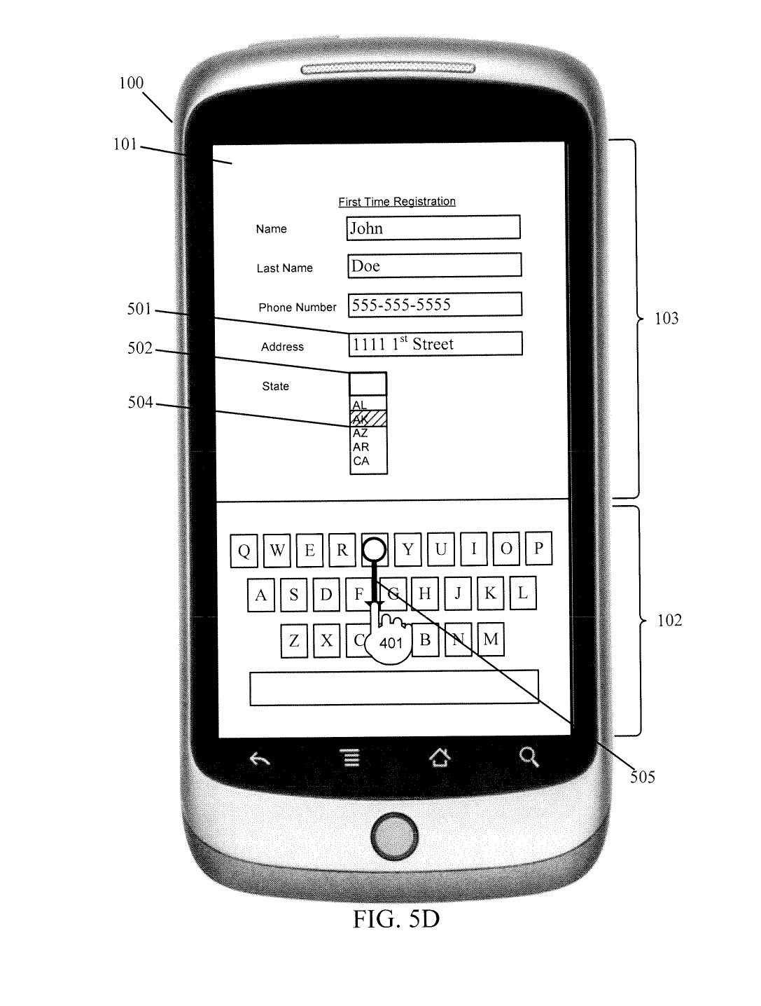

FIGS. 5A-5D, illustrate other examples in which user inputs corresponding to text and task selections are entered using a virtual keyboard, in accordance with various aspects of the subject technology. As shown in FIGS. 5A-5D, a form is being displayed on display area 103. The form may include one or more text entry fields, including text entry field 501 and 502. As shown in FIG. 5A, the “address” text field 501 is currently selected, and text is entered into text field 501 using the virtual keyboard 102. For example, the index finger of hand 401 of the user taps touchscreen 101 on the “T” key. A determination is made (e.g., at the selection type detection module 202) as to the type of input according to the methods described and it is determined that the tap refers to an actual text input. Thus, the “T” key is registered as the user input (e.g., at the text selection module 204). The letter “T” is provided for display in the text field 402, thereby providing an indication to the user that the “T” key was registered as the input.

Next, as shown in FIG. 5B, the finger of hand 401 may make a gesture 503 by moving down the virtual keyboard 102. In one example, the gesture may be continuous after the text selection shown in FIG. 5A or may be initiated as a separate gesture (e.g., by lifting the finger of hand 401 off the touchscreen after entering the last text selection and again tapping the touchscreen to initiate the input). According to characteristics of gesture 503 and the context of the gesture 503 it is determined that the user wishes to move to the next text filed, the “state” text field 502. Accordingly, as shown in FIG. 5B, the next text field 502 is selected in response to gesture 503. An indication of the recommendation is shown to the user, for example, by highlighting the text field 502 or moving the text entry cursor to the text field 502.

As shown in FIG. 5C, a menu 504 is provided for display, in association with text field 502, showing the options for the “state” text field. In one example, the menu may be displayed automatically as a result of performing the text field navigation in response to gesture 503. In another example, the user may make a separate gesture such as beginning to input text or making another gesture (e.g., holding down on the virtual keyboard for a long duration or other gesture indicating a desire to see the menu).

A gesture 505 may be entered at virtual keyboard 102 by the user while the menu 304 is being displayed, as shown in FIG. 5D. For example, the finger of hand 401 may make gesture 505 by moving down the virtual keyboard 102. In one example, the gesture may be continuous after the last gesture or text selection, or may be initiated as a separate gesture (e.g., by lifting the finger of hand 401 off the touchscreen and again tapping the touchscreen to initiate the input). According to characteristics of gesture 505 and the context of the gesture 505 it is determined that the user wishes to move down menu 504. Accordingly, as shown in FIG. 5D, the next text field 502 is selected. An indication of the recommendation is shown to the user, for example, by highlighting the next option on the menu 504.

In this manner, the user is able to perform tasks associated with text inputs in a quick and efficient manner using the text input mechanism. Accordingly, the user is not required to switch input mechanisms and/or discard the text input when performing tasks related to the text input.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

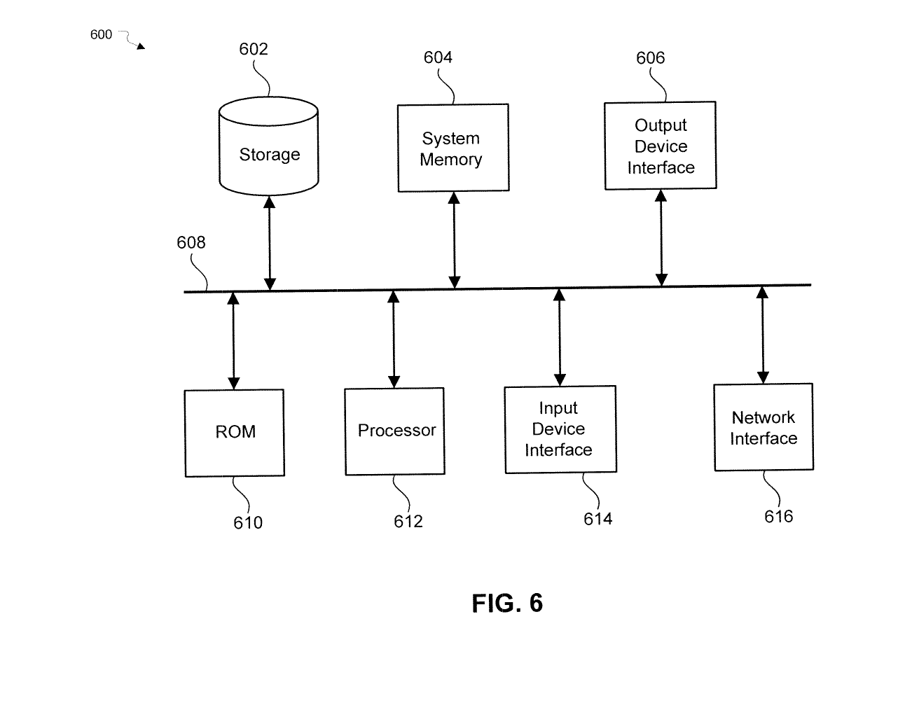

FIG. 6 conceptually illustrates an electronic system with which some implementations of the subject technology are implemented. Electronic system 600 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 600 includes a bus 608, processing unit(s) 612, a system memory 604, a read-only memory (ROM) 610, a permanent storage device 602, an input device interface 614, an output device interface 606, and a network interface 616.

Bus 608 collectively represents all system, peripheral, and chipset buses that communicatively connect the numerous internal devices of electronic system 600. For instance, bus 608 communicatively connects processing unit(s) 612 with ROM 610, system memory 604, and permanent storage device 602.

From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off Some implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such a random access memory. System memory 604 stores some of the instructions and data that the processor needs at runtime. In some implementations, the processes of the subject disclosure are stored in system memory 604, permanent storage device 602, and/or ROM 610. For example, the various memory units include instructions for facilitating entry of text and performing of tasks through inputs entered at a text input mechanism according to various embodiments. From these various memory units, processing unit(s) 612 retrieves instructions to execute and data to process in order to execute the processes of some implementations.

Bus 608 also connects to input and output device interfaces 614 and 606. Input device interface 614 enables the user to communicate information and select commands to the electronic system. Input devices used with input device interface 614 include, for example, alphanumeric keyboards and pointing devices (also called “cursor control devices”). Output device interfaces 606 enables, for example, the display of images generated by the electronic system 600. Output devices used with output device interface 606 include, for example, printers and display devices, such as cathode ray tubes (CRT) or liquid crystal displays (LCD). Some implementations include devices such as a touchscreen that functions as both input and output devices.

Finally, as shown in FIG. 6, bus 608 also couples electronic system 600 to a network (not shown) through a network interface 616. In this manner, the computer can be a part of a network of computers (such as a local area network (“LAN”), a wide area network (“WAN”), or an Intranet, or a network of networks, such as the Internet. Any or all components of electronic system 600 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for performing tasks associated with text inputs, the method comprising:
providing a text input mechanism on an electronic device, wherein the text input mechanism includes a plurality of keys, each key of the plurality of keys being selectable to cause a corresponding pre-defined entry corresponding to the key;
receiving, at the electronic device, an input by a user using the text input mechanism configured to receive a text selection input and task selection input at a time that the input is received;
determining if the input corresponds to a text selection or a task selection, wherein the text selection corresponds to the user performing an entry associated with a particular key of the plurality of keys associated with the input through the text input mechanism and the task selection corresponds to the user performing a gesture associated with a task that is independent from the pre-defined entry corresponding to the particular key of the plurality of keys;
registering the particular key corresponding to the input if the input corresponds to the text selection; and
performing the task corresponding to the input if the input corresponds to the task selection, wherein the task, which is independent from the pre-defined entry corresponding to the particular key of the plurality of keys, comprises moving a cursor that is being provided for display in a display area that is distinct from an area encompassed by the text input mechanism.

2. The method of claim 1, wherein the task further comprises moving the cursor independent of any fields being provided for display in the display area.

3. The method of claim 1, wherein performing the task comprises:
determining the task associated with the input; and
sending a request to perform the task.

4. The method of claim 1, wherein the determining is based at least in part on one or more criteria including criteria regarding characteristics of the input.

5. The method of claim 4, wherein the criteria regarding the characteristics of the input includes one or more of velocity, direction, location, duration.

6. The method of claim 1, wherein the determining is based at least in part on one or more criteria including criteria regarding a context of the input.

7. (canceled)

8. The method of claim 1, wherein the input comprises a swipe gesture across the text input mechanism to move the cursor through one or more items displayed to the user in the display area that is distinct from the area encompassed by the text input mechanism at the time the input is received.

9. The method of claim 8, wherein the one or more items are arranged in the display area along an axis, and wherein the swipe gesture across the text input mechanism is substantially parallel to the axis.

10. The method of claim 1, wherein one or more text suggestions are being provided for display in the display area, the input is towards the one or more text suggestions being displayed to the user in the display area that is distinct from the area encompassed by the text input mechanism while the input is entered at the text input mechanism, and wherein the task comprises one or more of moving the cursor through one or more text suggestions or selecting a text suggestion of the one or more text suggestions.

11. The method of claim 10, further comprising:
providing the one or more text suggestions for display to the user in response to text being entered using the text input mechanism.

12. The method of claim 10, wherein the text being entered comprises a first portion of a word or phrase, and wherein at least one of the one or more text suggestions comprises a second portion of the word or phrase.

13. The method of claim 10, wherein the text input comprises a word or phrase having an error, and wherein at least one of the one or more text suggestions comprises the word or phrase without the error.

14. The method of claim 1, wherein the task further comprises moving the cursor to highlight text being provided for display in the display area.

15. The method of claim 1, wherein one or more options of a menu are being provided for display in the display area that is distinct from, and non-overlapping with, the area encompassed by the text input mechanism, the input is towards the menu providing the one or more options being displayed to the user while the input is entered at the text input mechanism, and wherein the task comprises one or more of navigating the cursor through the one or more options of the menu or selecting one of the one or more options of the menu.

16. The method of claim 15, wherein the input comprises a swipe gesture to perform one or more of navigating the cursor through the one or more options of the menu or selecting one of the one or more options of the menu.

17. The method of claim 1, wherein a collection of one or more text fields are being provided for display in the display area that is distinct from the area encompassed by the text input mechanism, the input is towards the collection of the one or more text fields being displayed to the user in the display area that is distinct from the area encompassed by the text input mechanism while the input is entered at the text input mechanism and wherein the task comprises navigating the cursor from a first text field of the one or more text fields to a second text field of the one or more text fields.

18. The method of claim 17, wherein the gesture comprises a swipe gesture to navigate from the first text field to the second text field, wherein the swipe gesture comprises individually touching at least two of the plurality of keys.

19. A system for performing tasks associated with text inputs, the system comprising:
one or more processors; and
a machine-readable medium comprising instructions stored therein, which when executed by the processors, cause the processors to perform operations comprising:
receiving, at an electronic device, an input by a user using a text input mechanism, wherein the text input mechanism includes a plurality of keys, each key of the plurality of keys being selectable to cause a corresponding pre-defined entry corresponding to the key;
determining according to one or more criteria if the input corresponds to a text selection or task selection, wherein the text selection corresponds to the user performing an entry associated with a particular key of the plurality of keys through the text input mechanism and the task selection corresponds to the user requesting to perform a task independent of the pre-defined entries corresponding to the plurality of keys by performing a gesture that is different from the entry associated with the particular key of the plurality of keys;
identifying the particular key corresponding to the input if the input corresponds to the text selection; and
identifying the task corresponding to the input if the input corresponds to the task selection, wherein the task comprises navigating a display area that is non-overlapping with the text input mechanism, the navigating being independent of any fields being provided for display in the display area.

20. A non-transitory machine-readable medium comprising instructions stored therein, which when executed by a machine, cause the machine to perform operations comprising:
providing a text input mechanism on an electronic device, the text input mechanism comprising a virtual mechanism for inputting text, wherein the text input mechanism includes a plurality of keys, each key of the plurality of keys being selectable to cause a corresponding pre-defined entry corresponding to the key;
receiving, at the electronic device, an input by a user at the text input mechanism;
determining if the input corresponds to a text selection or a task selection, wherein the text selection corresponds to the user performing a selection of a particular key of the plurality of keys associated with the input through the text input mechanism and the task selection corresponds to the user performing a gesture corresponding to a task that is independent of the pre-defined entry corresponding to the particular key of the plurality of keys, wherein the gesture is distinct from the selection of the particular key of the plurality of keys;
registering the particular key corresponding to the input if the input corresponds to the text selection; and
performing the task corresponding to the input if the input corresponds to the task selection, wherein the task comprises highlighting an item being provided for display in an area that is non-overlapping with the text input mechanism.

21. The system of claim 19, wherein the navigating comprises navigating a page being provided for display in the display area that is distinct from, and non-overlapping with, the area encompassed by the text input mechanism.

22. The non-transitory machine-readable medium of claim 20, wherein the item comprises text.

23. The method of claim 1, wherein moving the cursor comprises navigating a page that is being provided for display in the display area, the moving being independent of any fields being displayed in the display area.
